(19) United States
(12) Patent Application Publication
(10) Pub. No.: US 2018/0276008 A1
(43) Pub. Date: Sep. 27, 2018

(54) METHOD AND APPARATUS FOR LOADING APPLICATION OF EMBEDDED MICROSYSTEM

(71) Applicant: Pax Computer Technology (Shenzhen) Co., Ltd., Shenzhen, Guangdong (CN)

(72) Inventor: Yike Zhao, Shenzhen, Guangdong (CN)

(21) Appl. No.: 15/556,628

(22) PCT Filed: Nov. 23, 2016
(86) PCT No.: PCT/CN2016/106924

§ 371 Date: Sep. 8, 2017

(30) Foreign Application Priority Data
Sep. 8, 2016 (CN) 201610815580.9

(51) Int. Cl. G06F 9/445; G06F 12/06

(52) U.S. Cl. CPC G06F 9/44521; G06F 2212/1044; G06F 12/0646

(57) ABSTRACT

The present application provides a method and an apparatus for loading an application of an embedded microsystem. The method includes: acquiring a size of a space occupied by an application to be loaded; starting calculation based on an end address of a storage space according to the size of the space occupied by the application to acquire a start address of the application in the storage space; and writing the application into the storage space according to the start address. The application is therefore stored at the end address of the storage space, which can be effectively adapted to the requirements of the dynamic changes of different system space and improve the utilization efficiency of the system resource.

### TECHNICAL FIELD

The present application pertains to the field of the embedded microsystem, more particularly relates to a method and an apparatus for loading an application of an embedded microsystem.

### BACKGROUND

With respect to products of embedded systems, in order to control the production cost and improve the competitiveness, computation and storage capacities of chips of the selected products are often restricted. In order to meet the requirements of different functions and occasions, different applications often need to be installed into products of similar series. Because the application requirements frequently changes, when applications and systems are integrated into hardware of the products at the same time, too many versions of the products will be resulted in, thereby causing maintenance difficulties.

In order to overcome the problem in the prior art that the frequent change of the application requirements of the products lead to too many versions and maintenance difficulties, the applications and the systems are separately arranged in the hardware of the products. When the system needs to execute the application, the application which needs to be executed is firstly compiled into an executable and linking format (ELF) file, and the ELF file is then downloaded to and executed in the embedded microsystem. Since the size of the space of the system may dynamically change, in the prior art, the loading of the file is started at a relatively conservative fixed address, such that the system resource of the product cannot be effectively utilized.

### BRIEF DESCRIPTION

It is an objective of the present application to provide a method for loading an application of an embedded microsystem, which aims at, among others, solving the problem in the prior art that the system resource cannot be effectively utilized when the application is loaded.

In one respect, one embodiment of the present application provides a method for loading an application of an embedded microsystem. The method comprises:

acquiring a size of a space occupied by an application to be loaded;

starting calculation based on an end address of a storage space according to the size of the space occupied by the application to acquire a start address of the application in the storage space; and

writing the application into the storage space according to the start address.

In combination with the first respect, in a first possible implementation of the first respect, the step of acquiring the size of the space occupied by the application to be loaded comprises:

performing a first linkage to the application according to a set and fixed link address to generate a temporary application file, and calculating a size of a space occupied by the temporary application file; and

the step of writing the application into the storage space according to the start address comprises:

performing a second linkage to the application according to the start address to generate a formal application file, and loading the formal application file to the storage space between the start address and the end address.

In combination with the first respect, in a second possible implementation of the first respect, the step of starting the calculation at the end address of the storage space according to the size of the space occupied by the application to acquire the start address of the application in the storage space comprises:

performing a subtraction operation between the end address of the storage space and the size of the space occupied by the application, and using an address acquired from the subtraction operation as the start address of the application in the storage space.

In combination with the first respect, in a third possible implementation of the first respect, before the step of starting the calculation at the end address of the storage space according to the size of the space occupied by the application to acquire the start address of the application in the storage space, the method further comprises:

judging whether the size of the space occupied by the application exceeds a remaining space of the storage space; and

sending an indication that the space is insufficient when the size of the space occupied by the application exceeds the remaining space of the storage space.

In combination with the first respect, in a fourth possible implementation of the first respect, the storage space comprises a systematic storage space for read only memory (ROM) and a systematic storage space for a random access memory (RAM).

In a second respect, an apparatus for loading an application of an embedded microsystem is provided by embodiments of the present application. The apparatus comprises:

an application space acquisition unit, configured to acquire a size of a space occupied by an application to be loaded;

a start address acquisition unit, configured to start calculation based on an end address of a storage space according to the size of the space occupied by the application to acquire a start address of the application in the storage space; and

an application loading unit, configured to write the application into the storage space according to the start address.

In combination with the second respect, in a first possible implementation of the second respect, the application space acquisition unit is particularly configured to:

perform a first linkage to the application according to a set and fixed link address to generate a temporary application file, and calculate a size of a space occupied by the temporary application file; and

the application loading unit is particularly configured to:

perform a second linkage to the application according to the start address to generate a formal application file, and load the formal application file to the storage space between the start address and the end address.

In combination with the second respect, in a second possible implementation of the second respect, the start address acquisition unit is particularly configured to:

perform a subtraction operation between the end address of the storage space and the size of the space occupied by the application, and use an address acquired from the subtraction operation as the start address of the application in the storage space.

In combination with the second respect, in a third possible implementation of the second respect, the apparatus further comprises:

a space judging unit, configured to determine whether the size of the space occupied by the application exceeds a remaining space of the storage space; and

an indication unit, configured to send an indication that the space is insufficient when the size of the space occupied by the application exceeds the remaining space of the storage space.

In combination with the second respect, in a fourth possible implementation of the second respect, the storage space comprises a systematic storage space for ROM and a systematic storage space for a RAM.

In the present application, the size of the space occupied by the application is firstly acquired, then, according to the size of the space and combining a position of the end address of the storage space, the start address for storing the application in the storage space is calculated, the loading of the application is started from the start address of the storage space and therefore ended at the end address, which can be effectively adapted to the requirements of dynamic changes of different system spaces and improve the utilization efficiency of the system resource.

### BRIEF DESCRIPTION OF THE DRAWINGS

FIG. 1 is a flow chart of a method for loading an application of an embedded microsystem provided by an embodiment of the present application;

FIG. 2 is a schematic diagram of loading of the application in a storage space provided by an embodiment of the present application; and

FIG. 3 is a structural schematic diagram of an apparatus for loading an application of an embedded microsystem provided by an embodiment of the present application.

### DETAILED DESCRIPTION

In order to make the purposes, technical solutions, and advantages of the present application clearer and more understandable, the present application will be further described in detail hereinafter with reference to the accompanying drawings and embodiments. It should be understood that the embodiments described herein are only intended to illustrate but not to limit the present application.

It is an objective of the embodiments of the present application to provide a method for loading an application of an embedded microsystem that is based on separation of the application from the system, to solve that for those embedded microsystem based on separation of the application from the system in the prior art, because the system space of the embedded microsystem may dynamically change, in order to be adapted to the requirement of the change in the size of the system space, it often needs to preset a fixed address at a position behind the system space as a start address for storing and loading the application. Such the storage manner makes the storage space of the application restricted, in addition, the size of the system space is also greatly restricted, which is not beneficial for the full and effective utilization of the limited storage space. The embodiments of present application are further described herein below in combination with accompany drawings.

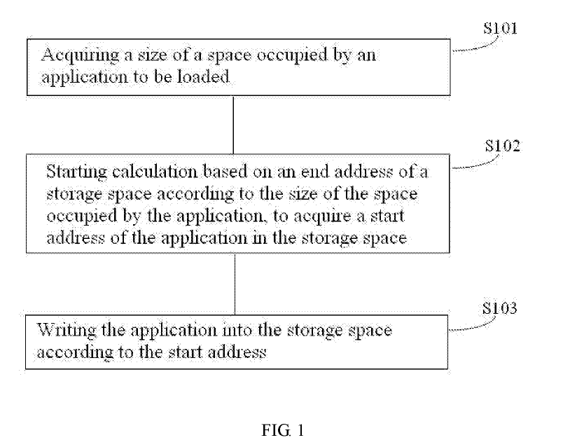

FIG. 1 shows a flow chart of a method for loading an application of an embedded microsystem provided by an embodiment of the present application, which is particularly described as follows:

Step S101: acquiring a size of a space occupied by the application to be loaded.

Specifically, the size of the space occupied by the application to be loaded can be a size of an ELF file which is generated by compiling and linking of the application, in which, the space of the application to be loaded comprises an occupied ROM space and an occupied RAM space, according to the file obtained from the compiling and liking of the application, a size of the required ROM space can be determined. In addition, in order to determine the size of the RAM space that the application requires to occupy, the application is operated and tested in advance to acquire the size of the RAM space occupied by the application. Also, the size of the space occupied by the application can be acquired by the following method:

According to a set and fixed link address, the application is performed with a first linkage to generate a temporary application file, and the size of the space occupied by the temporary application file is calculated. By the generated temporary application file, and by the size of the storage space occupied by the temporary application file when being operated in the system, the system can be loaded and operated combining with the practical requirements, such that the required storage space of the application, comprising the ROM space required by the application and the RAM space required by the application, in the system to be loaded can be more accurately and effectively determined.

In the above, the temporary application file refers to a file corresponding to the application loaded to a fixed address. Since the application file is used to test the size of the space occupied by the application, the temporary application file will be deleted after the test from which the size of the space occupied by the application is acquired.

Step S102: starting calculation based on an end address of the storage space according to the size of the space occupied by the application to acquire the start address of the application in the storage space;

Specifically, according to an embodiment of the present application, the step of starting the calculation at the end address of the storage space according to the size of the space occupied by the application to acquire the start address of the application in the storage space can particularly comprise:

performing a subtraction operation between the end address of the storage space and the size of the space occupied by the application, and using an address acquired from the subtraction operation as the start address of the application in the storage space.

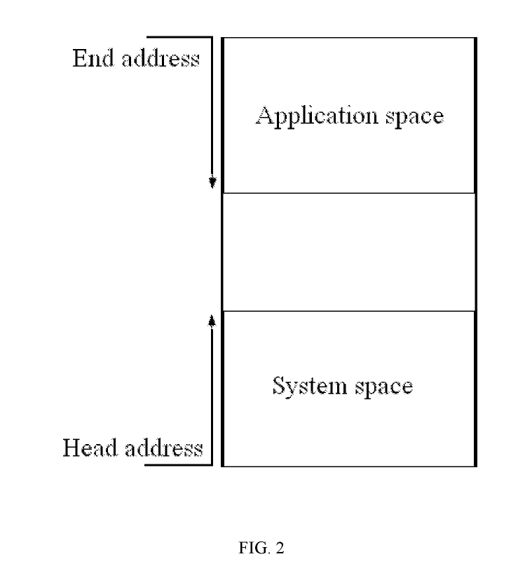

FIG. 2 shows a schematic diagram of storage structures of the application space and the system space, in which, the system space is configured to store system files, a storage manner is that a head address of the storage space is used as the start address and the system files are respectively stored in the storage space. For the system files, when the dynamic change occurs, the end address of the system space can be adapted to the requirement of the dynamic change in the size of the system files.

The application space is configured to store the application file. In the prior art, the storage of the application file generally uses a fixed storage address, for example, according to the size of the system files, the space required by the system files is estimated, and an address behind the space is given to store the program files since such address. Because waste in the storage space is generated between the application file and the system files, it is not beneficial for the utilization of the system resource.

As shown in FIG. 2, what is different from the prior art is that the size of the space occupied by the program file is acquired in advance, the size of the occupied space is subtracted from the end address of the storage space, so that the start address of the application in the storage space is acquired. In addition, the space of the application is a space between the start address thereof and the end address thereof.

For example, the end address of the whole storage space is 7999, the system files may dynamically change, so that the system files are respectively written into the storage space since 0. It is detected that the size of the space occupied by an application is 123, then, the start address of the application space is: 7999−123=7876, the application uses the start address 7876 as the start address to load the application file, and the whole application space is filled with the application file.

It is well understood that in a preferred embodiment of the present application, before the step of starting the calculation at the end address of the storage space according to the size of the space occupied by the application to acquire the start address of the application in the storage space, the method further comprises:

judging whether the size of the space occupied by the application exceeds a remaining space of the storage space; and

sending an indication that the space is insufficient when the size of the space occupied by the application exceeds the remaining space of the storage space.

The remaining space of the storage space refers to an additional space except the space occupied by the system files. Because the system files may dynamically change, an average value or a minimum value of the application file can be selected to perform calculation and judge. Thus, it can be judged that when the currently loaded application exceeds an average remaining space, the space may be insufficient; when the currently loaded application exceeds a maximum remaining space, the space is necessarily sufficient.

Step S103: writing the application into the storage space according to the start address.

Because the space occupied by the application file is effectively used, it is not required to reserve a fixed free space between the system files and the application files, the system resource can be more effectively utilized, which is beneficial for the utilization efficiency of the system. For the embedded microsystem, the method for loading the application in the above can be maintained by a standard method, which is beneficial to improve the convenience of the use.

For example, when the fixed address is used to perform the first linkage, given that an address range is 0x00000-0xfffff, then a fixed address 0x90000 in the middle is selected to begin the first linkage.

In a script of the first linkage, variables are used to identify space sizes of a text segment, a data segment, and a bss segment, then information of such variables is cited in the program, for example, a struct bin_info is added to the program to cite such variables, then the bin_info is identified as a particular segment in the link script.

After the sizes of the text segment, the data segment, and the bss segment of the first linkage are acquired, an ORIGIN attribute of a MEMORY command in the link script is modified to modify the link address, and the calculated end address is used to start a second linkage to generate an executable file.

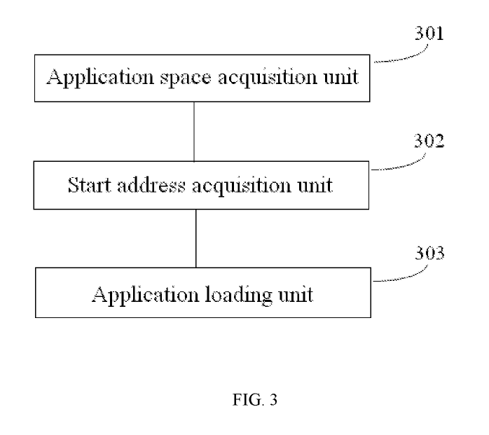

FIG. 3 is a structural schematic diagram of an apparatus for loading an application of an embedded microsystem provided by an embodiment of the present application, which is particularly described as follows:

The apparatus for loading an application of an embedded microsystem according to the embodiment of the present application comprises:

An application space acquisition unit 301, configured to acquire a size of a space occupied by an application to be loaded;

a start address acquisition unit 302, configured to start calculation based on an end address of a storage space according to the size of the space occupied by the application to acquire a start address of the application in the storage space; and

an application loading unit 303, configured to write the application into the storage space according to the start address.

Preferably, the application space acquisition unit is particularly configured to:

perform a first linkage to the application according to a set and fixed link address to generate a temporary application file, and calculate a size of a space occupied by the temporary application file; and

the application loading unit is particularly configured to:

perform a second linkage to the application according to the start address to generate a formal application file, and load the formal application file to the storage space between the start address and the end address.

Preferably, the start address acquisition unit is particularly configured to:

perform a subtraction operation between the end address of the storage space and the size of the space occupied by the application, and use an address acquired from the subtraction operation as the start address of the application in the storage space.

Preferably, the apparatus further comprises:

a space judging unit, configured to determine whether the size of the space occupied by the application exceeds a remaining space of the storage space; and

an indication unit, configured to send an indication that the space is insufficient when the size of the space occupied by the application exceeds the remaining space of the storage space.

Preferably, the storage space comprises a systematic storage space for ROM and a systematic storage space for a RAM.

FIG. 3 illustrates the apparatus for loading the application of the embedded microsystem, which corresponds to the method for loading the application of the embedded microsystem illustrated in FIG. 1, and is therefore not repeated herein.

In the embodiments of the present application, it should be understood that the disclosed apparatus and method can be realized by other implementations. For example, the embodiment involving the apparatus described in the above are merely schematic, for example, the division of the units are only a kind of logically functional division, other divisional modes can be adopted in practice, for example, multiple units or components can be combined with or integrated into another system, or some features can be neglected or not executed. In addition, the mutual coupling or direct coupling or communication connection indicated or discussed can also be realized by indirect coupling or communication connection via some interfaces, apparatuses, or units, and can adopt electric, mechanical, or other modes.

The units that are described as separate components can be or cannot be physically separated, and components indicated as units can be or cannot be physical units, that is, can be located at one position or distributed in multiple network units. The objective of the technical solution of the embodiments can be realized by selecting some or all of the units according to the practical requirements.

In addition, the functional units of different embodiments of the present application can be integrated into one processing unit, or such units exist independently and physically, or two or more units are integrated into one unit. The above integrated units can be realized by adopting the form of hardware or software functional units.

When realized in the form of the software functional units and sold or utilized as independent products, the integrated units can be stored in a computer readable storage medium, based on which, the technical solution of the present application, the portion contributing to the prior art, or a part or all parts of the technical solution can be essentially presented in the form of the software product, and the computer software product is stored in the storage medium and comprises a plurality of commands configured to enable a computing device (which can be a personal computer, a server, a network device, or the like) to execute all of or a part of the method according to embodiments of the present application. The aforementioned storage medium comprises a variety of media, such as, a USB disk, a mobile hard disk, a ROM, a RAM, a magnetic disk, or an optical disk, that can store program codes.

The aforementioned embodiments are only preferred embodiments of the present application, which are in no way used for limiting the present application. Any modification, equivalent replacement and improvement which are made within the spirit and the principle of the present application should be included in the scope of the present application.

1. A method for loading an application of an embedded microsystem, comprising:
acquiring a size of a space occupied by an application to be loaded;
starting calculation based on an end address of a storage space according to the size of the space occupied by the application, to acquire a start address of the application in the storage space; and
writing the application into the storage space according to the start address.

2. The method of claim 1, wherein
the step of acquiring the size of the space occupied by the application to be loaded comprises: performing a first linkage to the application according to a set and fixed link address to generate a temporary application file, and calculating a size of a space occupied by the temporary application file; and
the step of writing the application into the storage space according to the start address comprises: performing a second linkage to the application according to the start address to generate a formal application file, and loading the formal application file to the storage space between the start address and the end address.

3. The method of claim 1, wherein the step of starting the calculation at the end address of the storage space according to the size of the space occupied by the application to acquire the start address of the application in the storage space comprises: subtracting the size of the space occupied by the application from the end address of the storage space, and using an address acquired from the subtracting operation as the start address of the application in the storage space.

4. The method of claim 1, wherein before the step of starting the calculation at the end address of the storage space according to the size of the space occupied by the application to acquire the start address of the application in the storage space, the method further comprises:
judging whether the size of the space occupied by the application exceeds a remaining space of the storage space; and
sending an indication that the space is insufficient when the size of the space occupied by the application exceeds the remaining space of the storage space.

5. The method of claim 1, wherein the storage space comprises a systematic storage space for read only memory and a systematic storage space for a random access memory.

6. An apparatus for loading an application of an embedded microsystem, the apparatus comprising:
an application space acquisition unit, configured to acquire a size of a space occupied by an application to be loaded;
a start address acquisition unit, configured to start calculation based on an end address of a storage space according to the size of the space occupied by the application, to acquire a start address of the application in the storage space; and
an application loading unit, configured to write the application into the storage space according to the start address.

7. The apparatus of claim 6, wherein the application space acquisition unit is particularly configured to:
perform a first linkage to the application according to a set and fixed link address to generate a temporary application file, and calculate a size of a space occupied by the temporary application file; and
the application loading unit is particularly configured to:
perform a second linkage to the application according to the start address to generate a formal application file, and load the formal application file to the storage space between the start address and the end address.

8. The apparatus of claim 6, wherein the start address acquisition unit is particularly configured to:
subtract the size of the space occupied by the application from the end address of the storage space, and use an address acquired from the subtracting operation as the start address of the application in the storage space.

9. The apparatus of claim 6, wherein the apparatus further comprises:
a space judging unit, configured to determine whether the size of the space occupied by the application exceeds a remaining space of the storage space; and
an indication unit, configured to send an indication that the space is insufficient when the size of the space occupied by the application exceeds the remaining space of the storage space.

10. The apparatus of claim 6, wherein the storage space comprises a systematic storage space for read only memory and a systematic storage space for a random access memory.
